(19) United States
(12) Patent Application Publication
(10) Pub. No.: US 2014/0070632 A1
(43) Pub. Date: Mar. 13, 2014

(54) Magnetic Flux Drive

(71) Applicant: Harold Ariel Tavarez, Long Beach, CA (US)

(72) Inventor: Harold Ariel Tavarez, Long Beach, CA (US)

(21) Appl. No.: 13/573,368

(22) Filed: Sep. 12, 2012

(51) Int. Cl. H02K 41/02

(52) U.S. Cl. 310/12.04

(57) ABSTRACT

One embodiment of a propellantless propulsion device is a propulsion platform (40) comprising a base frame (42) with a permanent magnet (44) that provides the magnetic forces of attraction that accelerates a steel ball conveyor (48) toward the magnetic field of the permanent magnet (44) to generate a propulsive thrust (50) without the ejection of a mass of propellant from the platform (40). Another embodiment of a propellantless propulsion device is a magnetic flux drive (52) comprising a closed circuit (56) mounted on a base frame (54) with a magnetic accelerator (58) and a magnetic decelerator (60) that generates a propellantless propulsive thrust (64) with the energy of motion of a ferromagnetic conveyor (62). Other embodiments are described and shown.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

### Field of Invention

Current propulsion technology is propellant dependent. As a propellant, the propeller employs the air and water in the immediate surroundings. To produce thrust, a jet propulsion engine employs the air and water available in the external environment. In contrast, the rocket carries its own propellant for propulsion.

The dependence on propellant is the principal drawback, disadvantage, and limitation of today's propulsion technology. Nevertheless, a better solution that eliminates the dependence on propellant is at hand a magnetic flux drive. The magnetic flux drive is a propellantless propulsion engine that generates a propulsive force without the discharge of a mass of propellant from the magnetic flux drive.

To produce the thrust of propulsion without the ejection of a mass of propellant, the magnetic flux drive employs the mechanics of a magnetic collision. The mechanics in the collision acts in accordance with the principles of conservation of momentum and conservation of energy that take place in the transfer of momentum and kinetic energy in the collision between bodies.

While the principles of conservation of momentum between collisions of solid bodies are well known and well established, I believe the principles of momentum and momentum transfer are incomplete, not fully explored, and not fully taken advantage of for applications in propulsion. The teachings of the present and the prior art do not include and have not yet taken full advantage of the principles of conservation of momentum transfer between ferromagnetic bodies, permanent magnets, and electromagnets as moving frames of reference, and the magnetic fields produced by permanent magnets and electromagnets as stationary frames of reference.

I also believe that the present and the prior art have yet to learn how to take full advantage of the principles of conservation of momentum and momentum transfer between the magnetic fields produced by permanent magnets and electromagnets in motion and the magnetic fields produced by permanent magnets and electromagnets in a stationary frame of reference to produce a propellantless propulsion force.

As a source of potential energy and potential momentum, the prior art remains incomplete. The prior art does not include the teachings and advantages of the potential energy and potential momentum available in a magnetic field for propulsion. As a source of potential momentum and potential energy for motion, the magnetic forces and the magnetic energy present in a magnetic field are useful for propulsion. The magnetic energy in the magnetic field of a permanent magnet or in the magnetic field of an electromagnet are sources of potential energy and therefore sources of potential momentum that can establish the energy of motion and momentum that can be transferred to a body that can acquire, carry, and convey the energy of motion to a magnetic field. The body that can acquires, carry and convey the energy of motion to a magnetic field is referred to as a conveyor. In the presence of a magnetic field, the interaction of the conveyor with a magnetic field will transform the potential energy of motion and momentum in the conveyor into a propellantless propulsion force.

The body that acquire, carry, and convey the energy of motion to a magnetic field can be made of a ferromagnetic material, a permanent magnet, an electromagnet, or any other suitable material on which magnetic properties can be induced or are present. The magnetic forces present in a magnetic field can either attract, repel, or both attract and repel the carrier body at predetermined moments in time. In the presence of a magnetic field, the magnetic forces of attraction or repulsion between the carrier body, and a magnetic field; can accelerate the carrier body to a predetermined velocity that become; the energy of motion of the body. The same energy of motion in the carrier body can be conveyed to a magnetic field and converted by the magnetic field to a propulsion force by the means of a magnetic collision. The energy of motion is expressed as the momentum and kinetic energy contained in the carrier body which is also the conveying body.

In addition to the magnetic field, mechanical methods of acceleration can be employed for the acceleration of the carrier body. With the acceleration of the carrier body to a predetermined velocity, the momentum in the body can be quantified as the mass times the velocity of the body; while the kinetic energy can be quantified as one-half the mass times the square of the velocity of the body.

In addition to its incompleteness, the prior art have not taken advantage of the momentum and energy of motion transfer that takes place between a permanent magnet or an electromagnet in motion producing a magnetic field and a stationary magnetic field to produce a propulsion force without the ejection of a mass of propellant from the prime mover.

### SUMMARY OF THE INVENTION

The present invention employs the principles of conservation of momentum between a ferromagnetic body in motion and a magnetic field in a stationary frame of reference. The invention employs the magnetic forces and magnetic energy present in a magnetic field for propulsion. The magnetic energy in the magnetic field of a permanent magnet or in the magnetic field of an electromagnet serves as a source of potential energy and therefore potential momentum. The presence of potential energy and potential momentum in a magnetic field establish the energy of motion that can be transferred to a second body named a conveyor. The conveyor can be made of a ferromagnetic material or any other suitable material on which magnetic properties can be induced. The magnetic forces present in a magnetic field attract and accelerate the conveyor at the predetermined moments in time wherein the conveyor is in the presence of the accelerating magnetic field. The magnetic forces of attraction between the conveyor and the magnetic field; accelerate the conveyor to a predetermined high velocity to become the energy of motion of the conveyor. The energy of motion is expressed as the momentum and kinetic energy of motion in the conveyor.

In addition to the magnetic field, mechanical methods of acceleration are useful for the acceleration of the conveyor. With the acceleration of the conveyor to a predetermined high velocity, the momentum in the conveyor can be quantified as the mass times the velocity of the conveyor; while the kinetic energy can be quantified as one-half the mass times the square of the velocity of the conveyor.

By means of a magnetic collision achieved with the cooperation between a magnetic field and the magnetic properties of a conveyor, the magnetic field decelerates the conveyor from a predetermined high velocity to a predetermined lower velocity. In this manner, with the deceleration of the conveyor, the energy of motion of the conveyor becomes the source of propulsion that generates the thrust of propellantless propulsion without the emission of a mass of propellant from the magnetic flux drive.

### BRIEF DESCRIPTION OF DRAWINGS

FIG. 1A shows a first body in motion at a predetermined velocity approaching a second identical stationary body.

FIG. 1B shows the moment of collision between the first body in motion and the second stationary body.

FIG. 1C demonstrates a perfect elastic collision between the two identical bodies after the first body transfer all its momentum and kinetic energy to the previously stationary body.

FIG. 2 shows an inelastic collision between the first and the second body.

FIG. 3 shows another inelastic collision between the first and the second body.

FIG. 4A shows a ferromagnetic body in motion toward a stationary base platform with two identical permanent magnets mounted on the platform.

FIG. 4B illustrates a momentum transfer from the magnetic collision between the magnetic field of the two permanent magnets and the ferromagnetic body now trapped in the magnetic flux zone produced by the two permanent magnets on the platform.

FIG. 5 illustrates another outcome of a momentum transfer from the inelastic magnetic collision between a ferromagnetic body with excess momentum and the magnetic field of the two permanent magnets on the platform.

FIG. 6 shows a top plan view of a propulsion platform with a ferromagnetic steel ball conveyor on one end of the platform and a permanent magnet as a source of magnetic field on the opposite end.

FIG. 7 is a side view of the platform in FIG. 6.

FIG. 8A shows that, the movement of the ferromagnetic steel ball conveyor and the subsequent magnetic collision with the magnetic field of the permanent magnet on the platform; generates a pulse of thrust.

FIG. 8B shows that, the pulse of thrust produced by the magnetic collision between the steel ball conveyor and the magnetic field; propels the entire platform forward to a new position.

FIG. 9 is a top plan view of a magnetic flux drive that generates a propulsive thrust with the movement and the magnetic collision of a ferromagnetic conveyor in a closed circuit system.

FIG. 10 is a side view of the magnetic flux drive taken along AA′ in FIG. 9.

FIG. 11 is a front view cross section of the magnetic flux drive taken along BB′ in FIG. 9.

FIG. 12 is a top plan view of a magnetic flux drive taken along CC′ in FIG. 10.

FIG. 13 is a magnetic flux drive with the combination of an electromagnet for the acceleration of a ferromagnetic conveyor and a permanent magnet for the deceleration of the conveyor.

FIG. 14 shows a magnetic flux drive that employs an electromagnet for the acceleration of a conveyor and a second electromagnet for the deceleration of the conveyor.

FIG. 15 is a magnetic flux drive with a mechanical accelerator for the acceleration of a conveyor and a permanent magnet for the deceleration of the conveyor.

FIG. 16 is a cross sectional side view of the magnetic flux drive shown in FIG. 15 taken along the line DD′ in FIG. 15.

FIG. 17 is a cross section front view of the magnetic flux drive shown in FIG. 15, taken along the line EE′ in FIG. 15.

FIG. 18 is a cross sectional top plan view of the magnetic flux drive in FIG. 15 taken along the line FF′ in FIG. 16.

### OPERATION

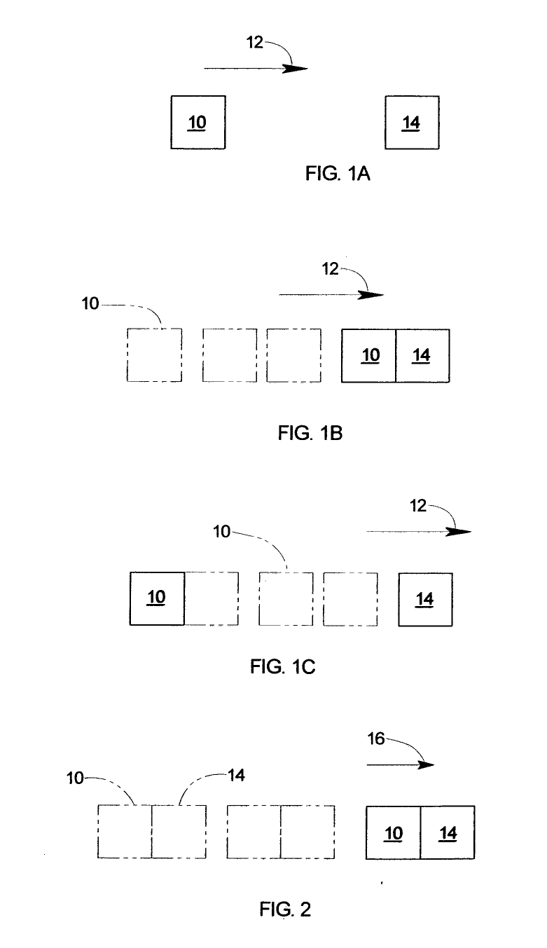

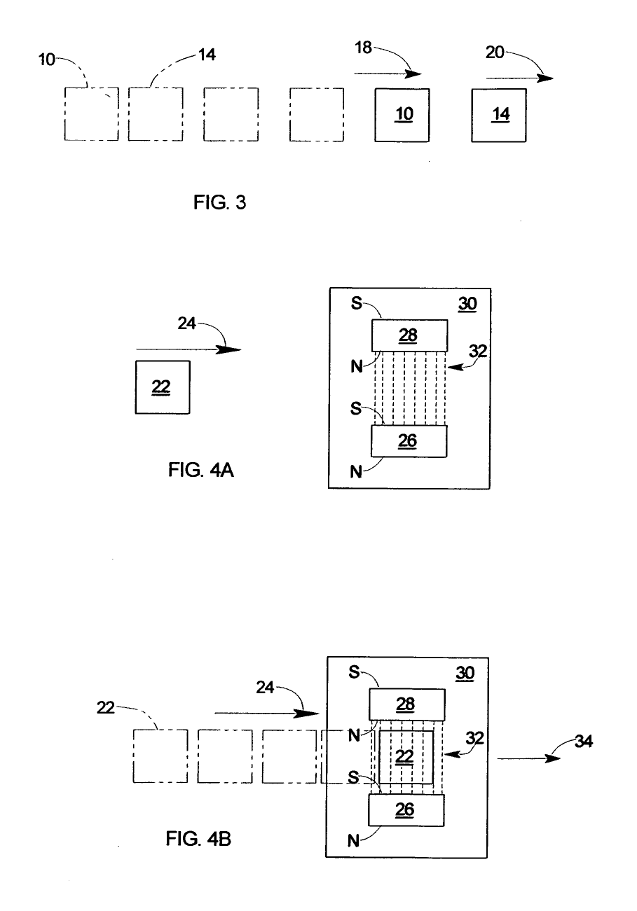

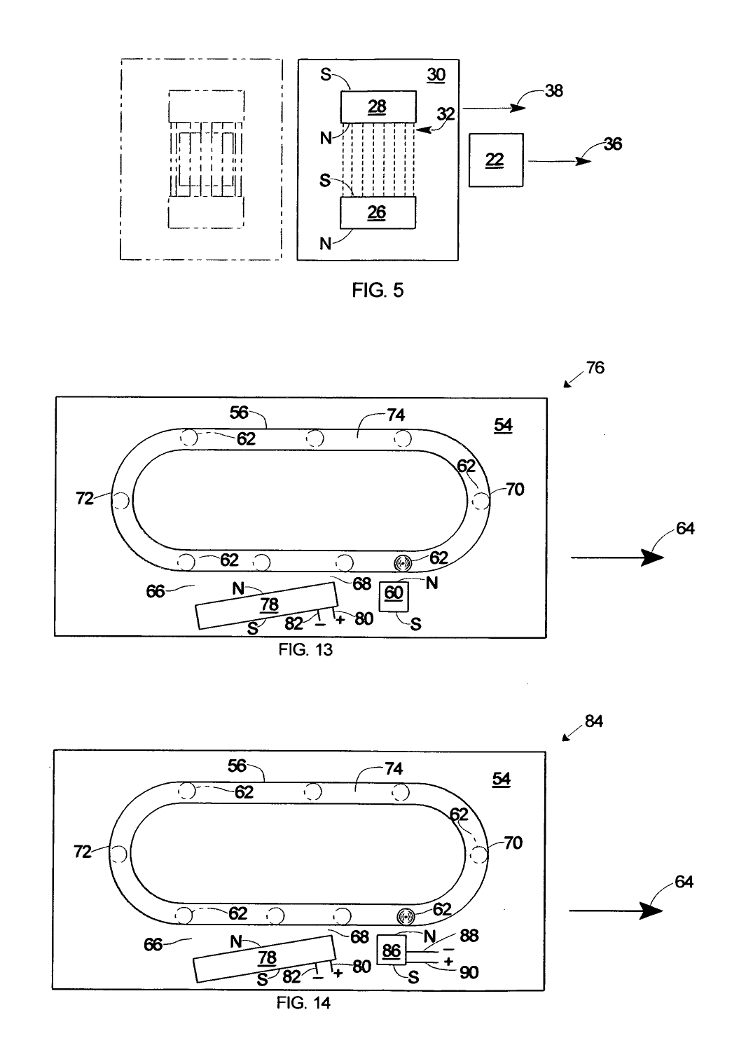

To better explain the theory of operation in the invention, FIG. 1A, 1B, 1C and FIG. 3 illustrate the conservation of momentum transfer by collision between solid bodies. FIG. 4A, FIG. 4B and FIG. 5 exemplifies the conservation of momentum transfer principle that takes place in a magnetic collision between a ferromagnetic body and a magnetic field. The physics of conservation of momentum and momentum transfer between solid bodies, by analogy, correspond to the physics of conservation of momentum and momentum transfer between a ferromagnetic body and a magnetic field.

FIG. 1A shows a first body 10 in motion with a velocity 12 approaching a stationary second body 14. The two bodies 10 and 14 are identical in every aspect. FIG. 1B shows, the moment of collision between the body 10 in motion and the stationary body 14. In accordance with the laws of conservation of momentum, collisions between bodies can be elastic or inelastic. An elastic collision is a collision on which both, kinetic energy and momentum are conserved. In an inelastic collision, only the momentum is conserved; while the kinetic energy is not.

FIG. 1C, a continuation of FIG. 1B, shows an elastic collision in which both, the kinetic energy and the momentum are conserved. After the collision, the body 10 decelerates abruptly and comes to a complete stop by transferring the momentum and kinetic energy from the body 10 to the stationary body 14. The transfer of energy and momentum from the collision accelerates the body 14. At the moment of collision, the initially stationary body 14 acts as a barrier that obstruct the movement of the body 10 and at the same time, the body 14 receives all the momentum and kinetic energy of the body 10. The blockage and therefore the collision bring the body 10 to a complete stop. During the collision, the second body 14 receives all the energy of motion in the body 10 and move away with the velocity 12.

Instead of an elastic collision, FIG. 2 shows the alternate possibility of an inelastic collision between the body 10 in motion and the stationary body 14. Due to the mechanics governing inelastic collisions, the two bodies 10 and 14 stick together as one body, and as one body, the two bodies 10 and 14 stick together to keep on moving together as one mass at the new velocity 16. In the inelastic collision between the bodies 10 and 14, only the total momentum is conserved. While the kinetic energy of the body 10, is not conserved after the collision.

FIG. 3 is an alternate outcome to the moment of collision in FIG. 1B. The outcome in FIG. 1B is an imperfect inelastic collision between the bodies 10 and 14. During the collision, the body 10 decelerates while the stationary body 14 accelerates. After the collision, the body 10 transfers some of its energy of motion to the stationary body 14; the body 10 decelerates, and then continues travelling in the same original direction at a new velocity 18. Simultaneously, the body 14, initially static, accelerates to a velocity 20. Part of the momentum and kinetic energy in the body 10 has been transferred to the body 14. In this example of an imperfect inelastic collision, the total momentum of the bodies 10 and 14 remains conserved. While the total kinetic energy of the bodies 10 and 14, is not conserved.

The descriptions above are illustrative examples relevant to the operation of the laws of conservation of momentum and conservation of momentum transfer as applicable to the collisions between two and more bodies.

Beyond the prior art, as it applies to the inventive concept, conservation of momentum, as it relates to momentum transfer by way of collision between bodies, is by analogy, also applicable to conservation of momentum conservation of momentum transfer between a ferromagnetic body in motion and a magnetic field in a stationary frame of reference. By analogy, the energy of motion transfer in the form of momentum and kinetic energy transfer between a ferromagnetic body in motion and a stationary magnetic field is classified as a magnetic collision. The principle of magnetic collision is also relevant to the conservation of momentum transfer between permanent magnets and electromagnets in motion, and a magnetic field in a stationary frame of reference. Similarly, conservation of momentum is also applicable to magnetic collisions between a magnetic field in motion and a stationary magnetic field that involve collisions between magnetic fields that attract or repel each other. The operant principles of magnetic collisions are also applicable to magnetic fields in motion and stationary ferromagnetic bodies.

Permanent magnets and electromagnets are articles of commerce; and therefore, the theory of operation as to how they generate a magnetic field and the details of their construction and operation is well known in the art. In the same way, ferromagnetic materials are also articles of commerce. Magnetic fields attract ferromagnetic bodies toward the magnetic field. Magnetic of like polarity repel each other, and magnetic fields of unlike polarity attract each other. These facts are well known in the art and will not be discussed in great details in the disclosure and the operation of the invention, only as necessary.

In FIG. 4A, a ferromagnetic body 22 travels at a velocity 24 toward a base 30. The magnetic field of permanent magnets 26 and 28, mounted on the base 30, generates a magnetic flux zone 32. A permanent magnet generates a magnetic field around the magnet that decrease in strength and intensity inversely proportional to the distance away from the magnet, and conversely; the magnetic field strength and intensity increase as the distance from the magnet decreases. The magnetic polarities of the magnets 26 and 28 are marked with the letters N for the magnetic North Pole, while the letter S indicates the magnetic South Pole. In between the space that separate the magnets 26 and 28, the magnetic field of each of the magnets 26 and 28 generate the magnetic flux zone 32.

In FIG. 4A, the approaching ferromagnetic body 22 carries momentum and kinetic energy. In FIG. 4B, show the arrival and capture of the body 22 by the magnetic forces present in the zone 32. In the presence of magnetic fields, ferromagnetic materials are attracted toward the magnetic field, in this case, the magnetic forces of attraction produced by the magnetic field of the magnets 26 and 28. Upon arriving on the vicinity of the magnets 26 and 28 on the base 30, the body 22 collides with the magnetic field of the magnets 26 and 28. Once inside the magnetic flux zone 32, the magnetic forces of attraction between the ferromagnetic body 22 and the magnets 26 and 28 decelerate the body 22 to capture the body 22 inside the magnetic flux zone 32. The capture of the body 22 inside the magnetic zone 32 occurs by way of a magnetic collision that completely stops the motion of the body 22. Inside the magnetic flux zone 32, the magnetic forces of attraction produced by the magnets 26 and 28 attract the bony 22 and acts as a barrier that completely decelerate and stop the motion of the body 22. The magnetic forces of attraction between the magnetic field of the magnets 26 and 28 also prevent the escape of the body 22 from the magnetic zone 32. By comparison, the magnetic collision of the ferromagnetic body 22 and the magnetic field forces in the magnetic zone 32 is similar to the collision between two solid bodies. The magnetic collision between the body 22 and the magnetic field of the magnets 26 and 28 in the zone 32 decelerate the body 22. The deceleration of the body 22 transfers the incoming energy of motion of the body 22 to the base 30. The momentum and kinetic energy transfer from the deceleration of the body 22 to the base 30; propels the base 30 with the body 22 together as one assembly with a velocity 34.

With the strength of the magnetic forces present in the flux zone 32 being equal to or greater than the momentum or the energy of motion of the body 22, the magnetic forces in the flux zone 32 act as a barrier that decelerate and bring the movement of the body 22 to a full stop. At the joining of the body 22 and the base 30 as one assembly, the sum of the masses on the base 30 increases, with the addition of the mass of the body 22, now trapped in the magnetic flux zone 32. This is an example of an inelastic magnetic collision between the body 22 and the assembly of the base 30 with the magnets 26 and 28.

Initially, the base 30 with the magnets 26 and 28 are stationary, and the body 22 approaches the base 30 with the velocity 34. The magnetic collision transfer of momentum and kinetic energy from the body 22 to the base 30 generates a propulsive force that propels the entire base 30 at a new velocity 34. The transfer of momentum and kinetic energy from the body 22 to the base 30 conserves the total momentum. In contrast, due to an increase in the total mass in the base 30 with the addition of the mass of the body 22 to the mass of the base 30 with the mass of the magnets 36 and 28, the kinetic energy input from the motion of the body 22 to the base 30 will not be conserved. This is an example of an imperfect magnetic inelastic collision between the body 22 and the magnetic field forces present in the magnetic zone 32 as exemplified in FIG. 4B.

A magnetic collision can be understood by comparison. The magnetic collision interaction between a ferromagnetic body in motion and a stationary magnetic field can be compared to a ball hitting a net. For example, consider a cannon ball fired toward a net designed to catch the cannon ball. On opposite sides, the net is tied to two posts with a portion of the posts buried on the ground for support. If the momentum of the cannon ball is less than the force it takes to break the net, the cannon ball will be caught by the net and brought to a complete stop. The momentum or the energy of motion of the cannon ball hitting the net will be transmitted to the posts partially buried on the ground.

However, if the momentum of the cannon ball is greater than the force it takes to break the net, the cannon ball will break the net and will continue moving along with the momentum leftover after breaking the net. The portion of the momentum that broke the net will be transmitted to the post buried on the ground and the ground itself. With the remaining momentum, the cannon ball will continue moving forward until stopped by an external force.

By analogy, a magnetic collision is similar the interaction between the net and the cannon ball. The magnetic field is the net that catches the cannon ball. And by comparison, the force of the collision between the magnetic field and the ferromagnetic body generates a propulsive force.

FIG. 5 exemplifies another type of inelastic magnetic collision between the body 22 and the magnetic field forces present in the zone 32. If the momentum of the body 22 is greater than the magnetic forces of attraction produced by the magnets 26 and 28 as present in the magnetic flux zone 32 and the ferromagnetic body 22, the excess momentum will allow the body 22 to escape from the magnetic zone 32 by breaking the tension of the magnetic forces of attraction between the body 22 and the magnets 26 and 28.

The body 22 enters the magnetic zone 22 with a higher speed than the exit speed at which the body 22 leaves the zone 32. The inelastic magnetic collision between the body 22 and the magnetic field forces present in the zone 32 divides the total momentum and kinetic energy of the body 22 between the body 22 and assembly of the base 30 with the magnets 26 and 28. The transfer of momentum from the body 22 to the stationary base 30 propels the base 30 together with the magnets 26 and 28 with a velocity 38. The remaining kinetic energy and momentum propels the body 22 with a velocity 36. The deceleration of the body 22 from the initial velocity 24 to the exit velocity 36; transfer part of the momentum and kinetic energy from the body 22 to the base 30. The energy of motion transfer from the body 22 to the base 30 conserves the initial total momentum present in the body 22, but does not conserve the total kinetic energy of the body 22. After the transfer of momentum and kinetic energy from the body 22 to the base 30, with the leftover momentum and kinetic energy, the body 22 escapes from the flux zone 32 at the new reduced velocity 36; while the base 30 with the magnets 26 and 28 moves on as one assembly at the new velocity 38. The total momentum is conserved, while the kinetic energy is not.

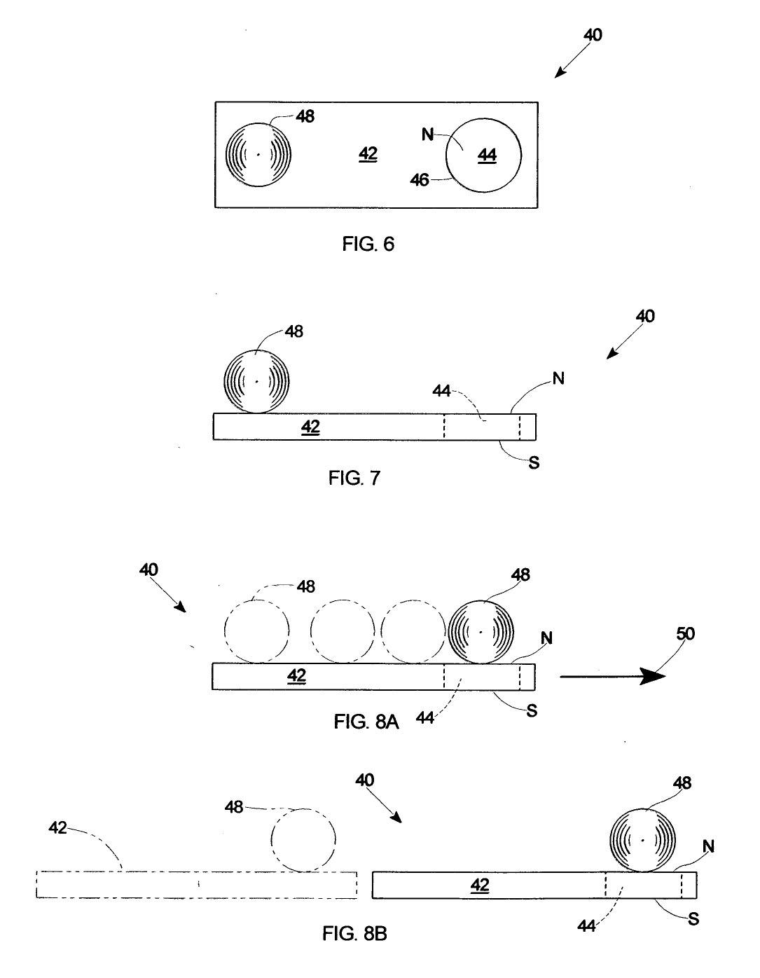

FIG. 6 is a top plan view of a propulsion platform 40 with a base frame 42, a permanent magnet 44 as a source of magnetic field, a cavity 46, and a conveyor 48 disposed in the magnetic field of the magnet 44. The cavity 46 is only a method for the attachment of the magnet 44 to the frame 42. Other suitable methods to attach the magnet 44 to the frame 42 can be used for the same purpose. The base frame 42 can be constructed of a non-magnetic material or a combination of non-magnetic and magnetic materials on suitable locations on the frame 40. The conveyor 48 can be made of a ferromagnetic material such as iron, steel or any material that can be made susceptible to a magnetic field, and on which a magnetic field can act upon.

FIG. 7, FIG. 8A and FIG. 8B are side views representations of FIG. 6. The permanent magnet 44 is a source of magnetic field located on one end of the frame 42, while the conveyor 48 is on the opposite end of the frame 42. In FIG. 6 only the North Pole N of the magnet 44 is visible. In FIG. 7, FIG. 8A and FIG. 8B, both, the magnetic North N and the magnetic South S Poles are marked.

In FIG. 7, the conveyor 48 disposed in the magnetic field of the magnet 44 is initially stationary at a predetermined distance away from the magnet 44. The predetermined distance from the magnet 44 to the conveyor 48 is such that, the placement of the conveyor 48 at that predetermined distance from the magnet 44 will cause the magnetic field of the magnet 44 to attract and accelerate the conveyor 48 toward the magnet 44. The magnetic forces of attraction in the magnetic field of the magnet 44 act upon the conveyor 48 to induce the acceleration and movement of the conveyor 48 toward the magnet 44.

In FIG. 8A, the flux of the magnetic field radiating from the magnet 44 attracts the stationary conveyor 48 and simultaneously induce the acceleration and movement of the conveyor 48 toward the magnet 44. In the platform 40, with no other forces acting on the conveyor 48, the magnetic field of the magnet 44 is the source that supplies the energy and therefore the magnetic forces that generates the magnetic attraction of the conveyor 48 toward the magnet 44. As the conveyor 48 gets closer to the magnet 44, the magnitude of the magnetic forces of attraction continuously increases as the approaching conveyor 48 encounters the increasingly strong magnetic field from the North Pole N of the magnet 44. Through action at a distance, the radiation of magnetic forces from the magnet 44 to the conveyor 48 generates the movement that accelerates the conveyor 48 toward the magnet 44. As a source of potential energy, through the magnetic force, the magnetic field of the magnet 44 is a source of potential momentum and therefore potential kinetic energy. The input of magnetic energy from the magnet 44 endows the conveyor 48 with momentum and kinetic energy.

Upon arriving to the North Pole N of the magnet 44, the conveyor 48 encounters the stronger magnetic field zone in the platform 40. In the magnetic North Pole N, the magnetic field acts as the barrier that decelerates the conveyor 48 to entrap and stop the conveyor 48 inside the magnetic zone of the North Pole N. The magnetic collision between the conveyor 48 and the magnetic North Pole N decelerates and stops the movement of the conveyor 48. Through the magnetic tension that exist between the magnetic forces of attraction in the magnetic field and the conveyor 48, the deceleration transfers the momentum and kinetic energy from the conveyor 48 to the magnet 44, and consequently, to the frame 42. The transfer of momentum and kinetic energy from the conveyor 48 generates a propulsive thrust 50. The propulsive thrust 50 is an impulse of propellantless thrust that propels the entire platform 40 together with the conveyor 48 as one assembly.

Upon arriving to the North Pole N region of the magnet 44, the conveyor 48 collides with the magnetic field of the magnet 44. The magnetic collision between the conveyor 48 and the magnetic field generates a momentum and kinetic energy exchange between the conveyor 48 and the magnet 44. The deceleration of the conveyor 48, brought about the magnetic collision generates the propulsive thrust 50, propels the entire platform 40 to a new position as shown in FIG. 8B. The propulsion of the platform 40 occurs by way of the force of the magnetic collision that generates the propellantless thrust 50 without the ejection of a mass of propellant from the platform 40. In this manner, the propulsion platform 40 acts as a teaching tool, a concept demonstrator, and as an object of amusement that can be used to demonstrate the validity of the energy of motion transfer by the method of a magnetic collision between a magnetic field and a ferromagnetic body. Moreover, the platform 40 can be employed as a starting place for new, improved and better prime movers.

It has been found experimentally that, the lower the friction between the frame 42 and the surface on which the platform 40 slides on, the longer the distance the platform 40 will travel in the direction of the thrust 50. An experimental platform 40 was constructed powered with a neodymium magnet. To produce another pulse of the propellantless thrust 50, the conveyor 48 must be moved back to the initial starting position on the frame 42. In this fashion, the propulsive cycle of the platform 40 can be repeated any number of times and the displacement distance measured and studied. On the frame 42, the conveyor 48 is placed at a distance such that only the magnetic forces of attraction between the conveyor 48 and the magnet 44 will do the work. A ferromagnetic steel ball was used as the conveyor 48.

In the frame of reference of the platform 40, the magnetic field produced by the magnet 44 and the magnetic forces of attraction present in the magnetic field is the source of momentum and kinetic energy that induce the motion of the conveyor 48 toward the magnet 44. A magnetic field is a source and a warehouse that supplies potential energy and potential momentum that can be converted into the propellantless thrust 50. With the platform 40 as a frame of reference, and with no external forces acting on the frame 42 and on the conveyor 48, the magnetic forces of attraction between the magnet 44 and the conveyor 48 become the only source of energy and momentum input to the conveyor 48. At the moment of collision between the conveyor 48 and the magnetic field of the magnet 44; the conveyor 48 cannot escape the magnetic forces of attraction between the magnetic North Pole N and the conveyor 48. The energy input from the magnetic field North Pole N to the conveyor 48 is less than the total magnetic energy available in the magnetic field of the magnet 44. At the North Pole N, the magnetic field forces from the magnet 44 acts as the barrier that decelerates and brings the conveyor 48 to a complete stop in order to prevent the escape of the conveyor 48 from the magnetic North Pole N region. Under these conditions, to escape, the conveyor 44 requires a greater amount of momentum and kinetic energy than the amount of momentum and kinetic energy that the magnet 44 can supply to the conveyor 48. In the platform 40, all the energy and momentum to produce the propulsive thrust 50 comes from the magnet 44 in the form of the magnetic forces of attraction between the conveyor 48 and the magnet 44.

Work done by definition is the product of the component of a force parallel to a displacement times the magnitude of the distance of the displacement. In the frame of reference of the platform 40, the magnetic field of the magnet 44 supplies the work done on the ferromagnetic conveyor 48. In the frame 42, the magnetic field of the magnet 44 is the source of potential energy that becomes a source of potential momentum that causes the movement of the conveyor 48 toward the magnetic field. Through the magnetic field, the magnetic forces of attraction exert a force on the conveyor 48 that causes the conveyor 48 to accelerate toward the magnet 44. The product of the magnetic attraction force and the distance traveled from one end of the platform 40 to the North Pole N of the magnet 44 constitutes the work done by the magnetic field on the conveyor 48. Upon arrival to the North Pole N, the conveyor 48 collides with the magnetic field of the magnet 44. The magnetic collision transforms the energy of motion and therefore the momentum of the conveyor 48 into the pulse of propellantless thrust 50 without the ejection of a mass of propellant from the frame 42 as seen in FIG. 8A. Accordingly, the magnitude of the thrust 50 causes the platform 40 to move forward to a new position as shown in FIG. 8B. By this method, the force of the propulsive thrust 50 produced without the ejection of a mass of propellant from the platform 40, is the means for propellantless propulsion.

During the entire process of propellantless thrust 50 creation, no energy is created or destroyed, merely changed from one form to another. The potential energy and therefore the potential momentum present in the magnetic field of the magnet 44, by interaction with the conveyor 48, changes to the energy of motion of the conveyor 48; and by process of a magnetic collision, the energy of motion in the conveyor 48 transform into a propellantless force useful for propulsion without propellant.

As a device useful as a prime mover for propulsion, the platform 40 comprises a base frame 42, a permanent magnet 44 as a source of magnetic field to act upon a ferromagnetic conveyor susceptible to the magnetic influence of the magnet 44. The magnetic forces of attraction in the magnetic field of the magnet 44, accelerates the conveyor 48 toward the magnetic field. A magnetic collision between the conveyor 48 and the magnetic field generates a propulsion force 50 without the ejection of a mass of propellant from propulsion platform 40.

As is, the propulsion platform 40 serves as a teaching tool, a device for amusement, and a basic science proof of concept and demonstrator. One limitation of the platform 40 is that it can only produce one pulse of thrust 50 at a time unless modified. For the next pulse of thrust, the conveyor 48 must be moved back to the initial starting position. However, further modifications to the platform 40 yield new, better, and more useful improvements that generate new and improved propellantless propulsion platforms that eliminate the need for the ejection of a mass of propellant from the prime mover.

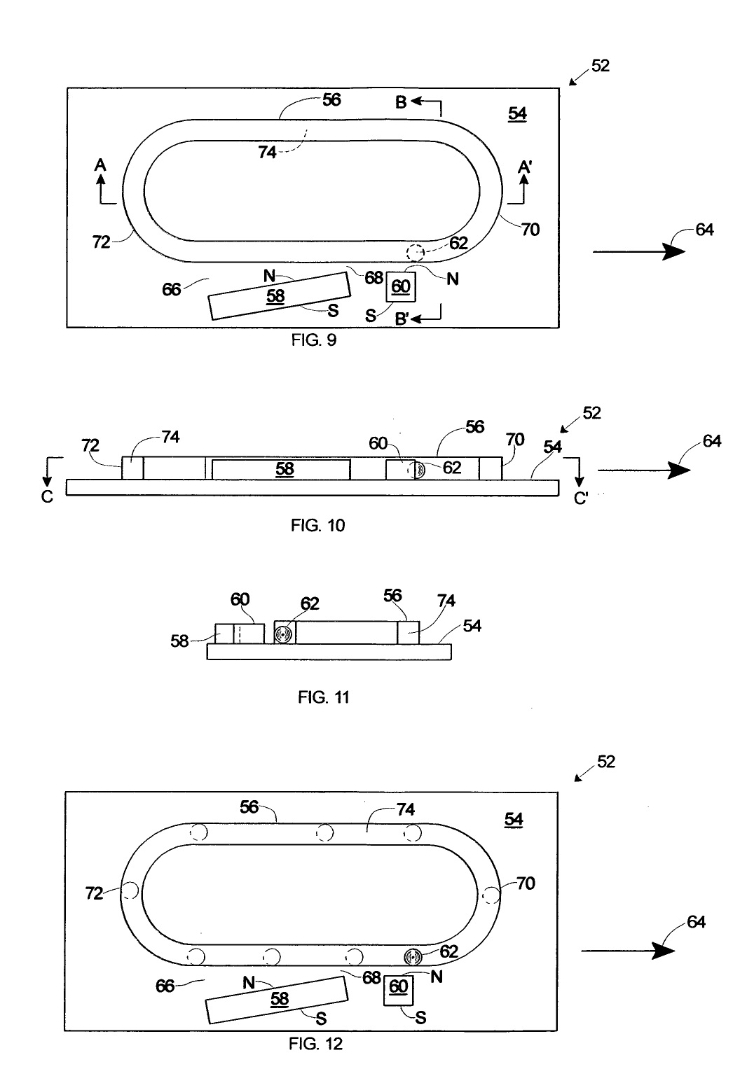

FIG. 9 through FIG. 12 shows new and improved permutations of the propulsion platform 40. The improved platform 40 is a magnetic flux drive 52 that generates a more continuous and repetitive cyclic thrust output in comparison to the platform 40.

FIG. 9 is a top plan view of the magnetic flux drive 52 with a base frame 54 for mounting a closed circuit 56 made of a non magnetic material, a permanent magnet as a magnetic accelerator 58 is a source of magnetic field that serves as a device for the acceleration of a ferromagnetic conveyor 62. The permanent magnet that makes up the accelerator 58 is magnetized through its thickness with a North Pole N, and a South Pole S. The end of the accelerator 58 located farther away from the circuit 56 forms a magnetic inlet 66. The end of the accelerator 58 opposite to the inlet 58 converges closer to the circuit 56 to form a magnetic outlet 68.

An additional permanent magnet in close proximity to the accelerator 58 is a magnetic decelerator 60 and another source of magnetic field for the deceleration of the conveyor 62. The permanent magnet that makes up the decelerator 60 is magnetized through its thickness with a magnetic North Pole N and a magnetic South Pole S. Via the method of a magnetic collision, the magnetic field of the decelerator 60 decreases the velocity of the conveyor 62 from a predetermined high velocity to a predetermined lower velocity. The conveyor 62 circulates inside the closed circuit 56. The enclosed circuit 56 is hollow inside. The hollow space inside the circuit 56 defines a track 74 that allows the conveyor 62 to travel in a continuous cyclical manner to interact periodically with the magnetic field of the accelerator 58 and the magnetic field of the decelerator 60. The interaction with the magnetic field of the accelerator 58 allows the conveyor 62 to gain momentum and kinetic energy. The energy in the magnetic collision and interaction between the conveyor 62 and the decelerator 60 generates a propulsive thrust 64. The conveyor 62 moves in the track 74 in a cyclical manner by passing from the magnetic accelerator 58 to the decelerator 60 at predetermined moments in time in order to decelerate the velocity of the conveyor 62 from a predetermined high velocity to a predetermined lower velocity. The deceleration of the conveyor 62 by way of a magnetic collision generates the propulsive thrust 64 without the ejection of a mass of propellant. After the conveyor 62 leaves the decelerator 60; the conveyor 62 travels the length of the track 74 and return to the accelerator 58 to repeat the cycle of propulsion. The drive 52 generates the propellantless propulsive thrust 64 without the ejection of a mass of propellant from the magnetic flux drive 52.

In the frame of reference of the drive 52, a propulsion cycle starts with the conveyor 62 in the magnetic inlet 66. In the proximity of the inlet 66, magnetic forces of attraction between the accelerator 58 and the conveyor 62 attract the conveyor to enter the magnetic zone of influence produced by the magnetic field of the permanent magnet that makes up the accelerator 58. In relation to the circuit 56, the accelerator 58 is mounted adjacent to and in close proximity to the circuit 56 at an angle of inclination best seen in FIG. 9 and FIG. 12. In the inlet 66, one end of the accelerator 58 is at a predetermined distance from the circuit 56; while the opposite end, at the outlet 68, the accelerator 58 converges toward the circuit 56.

In general, the magnetic field strength of a magnetic field source increases and decreases with the square of the distance from the source. In the magnetic inlet 66, the strength of the magnetic force of attraction the accelerator 58 exerts on the conveyor 62 is much less than the magnetic force of attraction the accelerator 58 exerts on the conveyor 62 in the outlet 68. For example, a comparison of the magnitude of the magnetic force of attraction the accelerator 58 exerts on the conveyor 62 as it travels the length of the accelerator 58 shows that; if at the inlet 66, the distance from the circuit 56 to the accelerator 58 is twice as far as the distance from the circuit 56 to the accelerator 58 at the outlet 68; then, the strength of the magnetic force of attraction the accelerator 58 exerts on the conveyor 62 in the inlet 66 is about, one-fourth the magnitude of the magnetic force of attraction the accelerator 58 exerts on the conveyor 62 in the outlet 68. The increasing magnetic field strength comes about the decrease in distance from the circuit 56 to the accelerator 58, as the accelerator 58 converges closer to the circuit 56 in the outlet 68.

As the conveyor 62 travel the length of the accelerator 58, from the inlet 66 to the outlet 68, the conveyor 62 encounters an increasing magnetic flux that accelerates the conveyor 62 toward the magnetic outlet 68. The acceleration allows the conveyor 62 to gain a predetermined excess in the energy of motion in the form of an excess of momentum and kinetic energy as the velocity of the conveyor 62 increases. The total gain in momentum and kinetic energy is greater than the energy of motion required to overcome the magnetic forces of attraction between the magnetic field and the conveyor 62.

From the outlet 68, the speeding conveyor 62 travels from the accelerator 58 to the decelerator 60 where the magnetic collision between the conveyor 62 and the magnetic field of the decelerator 60 decelerates the conveyor 62. As the conveyor 62 spends momentum and kinetic energy to overcome the magnetic tension that exist in the magnetic forces of attraction between the conveyor 62 and the decelerator 60, the magnetic collision between the speeding conveyor 62 and the magnetic field of the accelerator 60 generates the thrust 64 without the ejection of a mass of propellant from the magnetic flux drive 52. With the leftover momentum and kinetic energy, the conveyor 62 break free from the hold of the magnetic field in the decelerator 60.

From the decelerator 60, the conveyor 62 proceeds to a first u-turn 70. At the completion of the first u-turn 70, the conveyor 62 reverses its direction of travel in the track 74. After the completion of the first u-turn, the conveyor 62 travels to a second u-turn 72 where for the second time, the conveyor reverses its direction of travel once again and return to the initial starting point in the inlet 66. At the inlet 66, the conveyor 62 starts to repeat a new cycle of propulsive thrust output.

FIG. 10 is a side plan view of the magnetic flux drive 52, taken along AA′ in FIG. 9 to show the cross section of the closed circuit 56. FIG. 10 shows the conveyor 62 leaving the magnetic field zone of the magnetic decelerator 60. FIG. 10 also shows the predetermined cross sections of the first u-turn 70 and the second u-turn 72. The predetermined cross section of the closed circuit 56 is any suitable shape that allows the easy traffic of the conveyor 62 in the track 74. FIG. 11 is a front side view of the flux drive 52, taken along BB′ in FIG. 9. In both FIG. 9 and in FIG. 11, the cross section of the circuit 56 is shown as a rectangular section and the conveyor 62 is shown as the circular shape of a sphere. However, the shape of the conveyor 62 should not be considered as a limitation since other shapes for the conveyor 62 can be just as useful. Moreover, even though in FIG. 11, the predetermined cross section of the permanent magnets that make up the magnetic accelerator 58 and the magnetic decelerator 60 are shown as rectangular cross sections, this choice of shape is not a limitation since other predetermined shapes can be equally effective and adaptable to the task.

FIG. 12 is a top plan view of the magnetic flux drive 52, taken along CC′ in FIG. 10 to show the entire enclosed space that characterize the track 74 inside structure of the circuit 56. The track 74 occupies the entire hollow length of the circuit 56. During the operation that generates the propellantless thrust 64; the conveyor 62 moves in the track 74 in a cyclical manner. Inside the circuit 56, the traffic of the conveyor 62, starts in the inlet 66 and ends in the same place, the inlet 66. As a reference, the conveyor 62 travels in the counter clockwise direction in the track 74. In FIG. 12, the conveyor 62 is just about to leave the decelerator 60.

In the dive 52, the accelerator 58 is mounted in close proximity to, adjacent to, or contiguous to the circuit 56; with a sloping angle of inclination that converges toward the circuit 56, best seen in FIGS. 9 and 12. With one end of the accelerator 58 closer to the circuit 56 to form the magnetic outlet 68. While the other end of the accelerator 58 is farther away from the circuit 56 to form the magnetic inlet 66. At the inlet 66, the magnetic forces of attraction are weaker due to the farther distance away from circuit 56. In contrast, the magnetic forces in the magnetic field of the accelerator 58 are stronger in the vicinity of the outlet 68 due to the convergence that brings the accelerator 58 closer to the circuit 56. During the traffic of the conveyor 62 through the zone of magnetic influence produced by the magnetic accelerator 58, from the inlet 66 to the outlet 68, the conveyor 62 accelerates to a predetermined high velocity. At the inlet 66, the magnetic forces of attraction between the conveyor 62 and the accelerator 58 are relatively of a lesser magnitude in comparison to the higher magnitude of the magnetic forces at the outlet 68. As the movement of the conveyor 62 in the track 74 progresses along the length of the accelerator 58, from the inlet 66 to the outlet 68, the conveyor 62 encounters a continuous increase in the strength of the magnetic field brought about the convergence of the accelerator 58 toward the circuit 56. The increase of strength in the magnetic field forces from the accelerator 58 is due to the progressive decrease in the distance between the conveyor 62 and the distance to the accelerator 58.

As a rule, the strength of the magnetic force decreases with the square of the distance from the source, the farther away from the source, the weaker the field strength; similarly, the closer the distance to the source, the stronger the magnitude of the magnetic force. In the outlet 68, the conveyor encounters a much stronger magnetic field relative to the magnitude of the magnetic forces in the inlet 66. As the conveyor 62 accelerates in the track 74; the conveyor 62 acquires the energy of motion in the form of momentum and kinetic energy. By the time the conveyor 62 reaches the outlet 68, the conveyor 62 has acquired a predetermined velocity, momentum and kinetic energy that allow the conveyor 62 to pass through the outlet 68 and continue its movement toward the decelerator 60.

Upon arriving to the decelerator 60, the conveyor 62 collides with the magnetic field of the decelerator 60. The force of the magnetic collision generates a propellantless force shown as the propulsive thrust 64. The magnetic collision between the conveyor 62 and the magnetic field of the decelerator 60 is an inelastic collision that transfers part of the energy of motion in the conveyor 62 to the decelerator 60. The inelastic collision conserves the momentum but does not conserve the kinetic energy.

Between the inlet 66 and the outlet 68, the conveyor 62 acquires a predetermined amount of momentum and kinetic energy greater than the amount of momentum and kinetic energy necessary to overcome the tension of the magnetic forces of attraction between the conveyor 62 and the decelerator 60. As the conveyor goes through the magnetic field of the decelerator 60, a predetermined amount of the energy of motion is spent in overcoming the magnetic forces of attraction between the decelerator 60 and the conveyor 62. The energy of motion and the force of the collision becomes the propulsive thrust 64 in accordance to Newton's second law of motion that says: Force is equal to the product of mass times the acceleration. After passing through the magnetic field zone of the decelerator 60, with the left over momentum and kinetic energy, the conveyor 60 continues to travel to the first u-turn 70 where the conveyor makes a 180° turn around and continues travelling in the in the track 74 toward the second u-turn 72. After the completion of a 180° turn around in the second u-turn 72, the conveyor 62 arrives in the inlet 66 to start another thrust output cycle of propellantless propulsion. This repetitive operation comprises one cycle of propellantless thrust output in the magnetic flux drive 52. In this manner, the magnetic flux drive generates a cyclical propulsive thrust 64 output that accelerates the magnetic flux drive 52 and any vehicle of which the drive 52 is part of. Propelling the drive 52 with the vehicle to which the drive 52 is attached to in the direction of the thrust 64. The propulsive thrust 64 is produced without the ejection of a mass of propellant from the magnetic flux drive 52.

In FIG. 12, inside the circuit 56, the description of the movement of a single conveyor 62 in the track 74 is shown with phantom lines. As a reference, the phantom lines description for the movement of a single conveyor 62 also implies that, a plurality or a single conveyor 62 can be employed to amplify the magnitude of the cyclical output and to make the cyclical thrust 64 output of the drive 52 a more continuous force.

In the description of additional embodiments of new and improved modifications made to the drive 52, only the changes or the modifications that represent the improvements will be shown. All the other unmodified components of the magnetic flux drive 52 will be shown as they are.

FIG. 13 is an improved magnetic flux drive 76. The drive 76 is a modification of the magnetic flux drive 52. The modification to the drive 52 consists of the replacement of the accelerator 58 with an electromagnetic accelerator 78 as the means for the acceleration of the conveyor 62. Instead of a permanent magnet, the accelerator 78 employs an electromagnet to produce the magnetic field that accelerates the conveyor 62. The electromagnet is magnetized through its thickness or as needed to produce the magnetic that accelerates the conveyor 62. Electric power input for the accelerator 78 from a conventional electric power source (not Shown) is fed to the accelerator 78 through connecting electric terminals 80 and 82. The power source can include switching means that allows the electromagnet to sense, switch on and switch off at predetermined moments in time during the acceleration of the conveyor 62. The electric powered state of the electromagnet in the accelerator 78 is shown with the plus “+” and minus “−” signs on the terminals 80 and 82. The accelerator 78 generates the magnetic field that accelerates the conveyor 62 to the predetermined velocity to provide the momentum and kinetic energy of the conveyor 62. The force of the magnetic collision between the conveyor 62 and the magnetic field of the decelerator 60 generates the propulsive thrust 64 without the emission of a mass of propellant from the drive 76.

FIG. 14 shows an improved magnetic flux drive 84. The drive 84 is another embodiment and a further improvement to the drive 76 and therefore the drive 52. The modifying improvement consists of the replacement of the permanent magnet that makes up the decelerator 60 with an electromagnet for the construction of an electromagnetic decelerator 86. An electromagnet serves as the source of magnetic field and the means that generate the magnetic field that decelerate the conveyor 62. The electromagnet that makes up the decelerator 86 generates the magnetic field that decelerates the conveyor 62 from a predetermined high velocity to a predetermined lower velocity. The deceleration of the conveyor 62 caused by the force of the magnetic collision between the conveyor 62 and the magnetic field of the decelerator 86 transforms the momentum and kinetic energy of the conveyor 62 into the propellantless propulsive thrust 64. As in the previous magnetic flux drives 52 and 76, a plurality or a single conveyor 62 can be employed to produce the propulsive thrust 64 without the ejection of a mass of propellant from the drive 84.

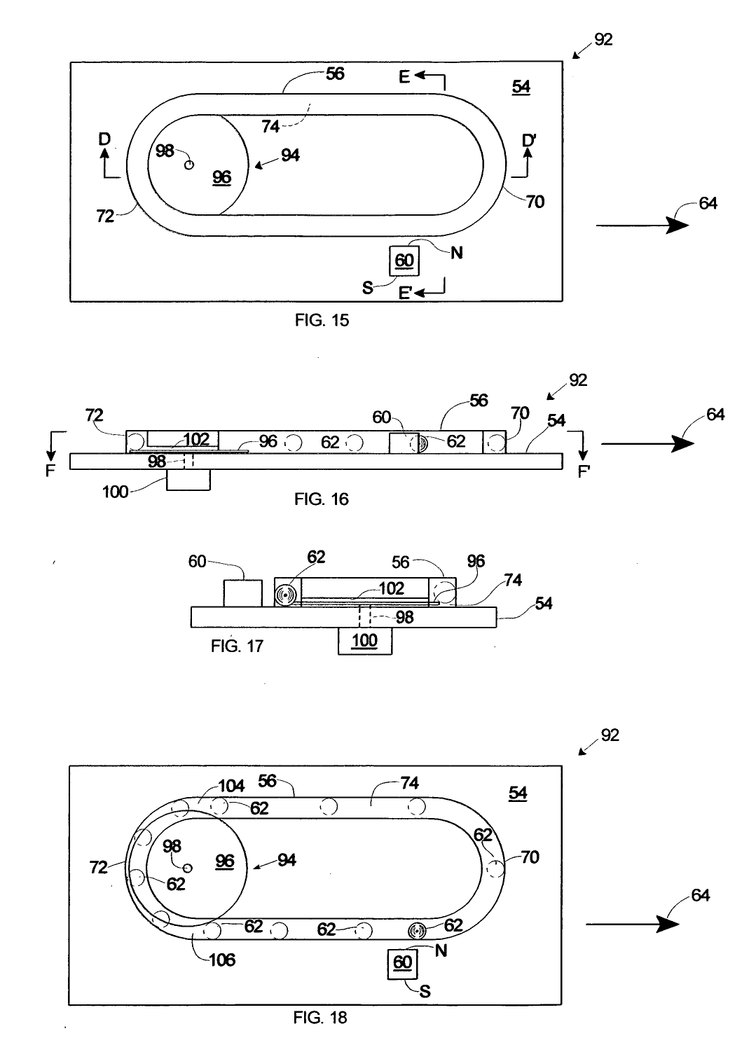

Referring to FIG. 15 to FIG. 18, FIG. 15 is the embodiment of an improved magnetic flux drive 92. The drive 92 has been improved by replacing the source of magnetic field that accelerates the conveyor 62 with a mechanical accelerator 94. The accelerator 94 accelerates the conveyor 62 to the predetermined velocity that defines the high energy momentum and kinetic energy of the conveyor 62 without the aid of a magnetic field. From the energy of motion obtained from the acceleration of the conveyor 62, the force of the magnetic collision, and the deceleration of the conveyor 62 that takes place in the magnetic field of the decelerator 60, the magnetic collision generates a force of a predetermined magnitude that defines the propellantless propulsive thrust 64 in the magnetic flux drive 92.

FIG. 16 is a cross section of the drive 92 taken along the line DD′ to shows with further details the mechanical accelerator 94.

FIG. 17 is a front view of the drive 92 taken along the line EE′ in FIG. 15 to show a view of a slot 102 with an internal cross section view of the closed circuit 56.

FIG. 18 is another view of the drive 92 taken along the line FF′ in FIG. 16 to show the path the conveyor 62 travels in the track 74 inside the circuit 56. The path the conveyor 62 travels in the track 74 is shown at various locations inside the circuit 56. The phantom lines descriptions of the conveyor 62 also imply that a plurality of conveyors 62 can be employed to augment the thrust 64 output in the drive 92. By employing more than one conveyor 62, the magnitude of the frequency and amplitude the thrust 64 can be amplified and made more continuous.

The accelerator 94 has a rotor 96 attached to a central shaft 98 of a motor 100 that provides the rotary energy to spin the rotor 96 that accelerate the conveyor 62 to the predetermined velocity that interact with the magnetic field of the decelerator 60 to produce the thrust 64. As a mechanical device and a means for the acceleration of the conveyor 62, the accelerator 94 can be any of the type of mechanical pumps or centrifugal rotors with vanes commercially available and suitable for the acceleration of the conveyor 62.

In the drive 92, the force of the magnetic collision that decelerates the conveyor 62 in the decelerator 60 generates the propulsive thrust 64 without the ejection of a mass of propellant from the magnetic flux drive 92. A rotor inlet 104 defines the location in the circuit 56 where the conveyor 62 enters the rotor 96. A rotor outlet 106 defines the exit where the conveyor 62 leaves the rotor 96 with a gain in its energy of motion. A slot 102 has been added to the circuit 56 to allow a portion of the rotor 96 to penetrate into the space of the track 74 inside the circuit 56. The slot 102 is best seen in FIG. 16 and FIG. 17.

After the force of the magnetic collision decelerates the conveyor 62 with the magnetic field of the decelerator 60, and as the conveyor 62 travels in the track 74 towards the spinning rotor 96, the residual leftover energy of motion in the conveyor 62 after the magnetic collision pushes the conveyor 62 onto the rotor 96. Thereon, the spinning rotor 96 accelerates the conveyor 62 to the predetermined velocity that endows the conveyor 62 with additional momentum and kinetic energy. After the conveyor 62 leaves the accelerator 94 with a gain of momentum and kinetic energy, the conveyor 62 proceeds to the decelerator 60 where the force of the magnetic collision between the conveyor 62 and the magnetic field produced by the permanent magnet that make up the decelerator 60 generates the propulsive thrust 64 without the ejection of a mass of propellant from the magnetic flux drive 92.

In addition to the reaction of the magnetic forces of attraction that prevent the escape of the conveyor 62 from the magnetic field zone of the decelerator 60, the magnetic forces of attraction between the conveyor 62 and the decelerator 60 acts as a barrier that decelerate the conveyor 62. However, given the predetermined excess of momentum and kinetic energy obtained during the period of acceleration the conveyor 62 spend in the accelerator 94, the conveyor 62 manages to escape magnetic field zone of the decelerator 60. The deceleration of the conveyor 62 in the decelerator 60 transfer a portion of the conveyor 62 momentum and kinetic energy to the decelerator 60. The excess leftover energy after the magnetic collision drives the conveyor 62 back to the accelerator 94. With the force of the magnetic collision, the drive 92 generates the propulsive thrust 64 with the magnetic tension forces that exist between the magnetic forces of attraction in the magnetic field and the conveyor 62. The propellantless thrust 64 is produced without the ejection of a mass of propellant from the drive 92.

With the remaining residual momentum and kinetic energy leftover, the conveyor 62 continues in motion toward the first u-turn 70 where the conveyor 62 makes a 180° turn and continues in the track 74 traveling toward the rotor 96. In the rotor inlet 104, the excess momentum pushes the conveyor 62 onto the rotor 96. From the inlet 104, best seem in FIG. 18, the rotor 96 carries and accelerates the conveyor 62 along the second u-turn 72. At the outlet 106, the conveyor 62 leaves the rotor 96 with a net gain in momentum and kinetic energy.

By the method of a magnetic collision between the conveyor 62 and the magnetic field of the decelerator 60, the conveyor 62 generates the propulsive thrust 64. With the thrust 64, the magnetic flux drive 92 propels the vehicle or the frame to which the drive 92 is attached to without the ejection of a mass of propellant from the vehicle, the frame or the drive 92.

### CONCLUSIONS, RAMIFICATIONS, AND SCOPE

The propulsion platform 40 shows the fundamental method and principle of propellantless propulsion, in essence, the inventive concept. In the platform 40, the magnet 44, at different times performs the function of the accelerator and the decelerator. Initially, the magnetic field of the permanent magnet 44 starts as the accelerator and the source of energy that accelerates and endows the conveyor 48 with the energy of motion that becomes the propulsive thrust 50 in a collision. Over the length of the distance the conveyor 48 travels to the magnet 44 on the opposite end of the frame 42, the magnetic field incrementally increases in strength and intensity and at the same time incrementally accelerates the conveyor 48 to the final speed of collision with magnetic field of the magnet 44. In the end, upon arrival to the North Pole N, the magnet 44 becomes the decelerator of the conveyor 48. At the moment of collision with the magnetic field of the magnet 44, the force of the collision converts the energy of motion in the conveyor 48 into the force of the propellantless propulsive thrust 50 without the ejection of a mass of propellant from the platform 40. In addition to the propellantless magnetic flux drives discussed and described in the text and illustrations; and as a new beginning, the platform 40 and the abovementioned prime movers, through further modifications and improvements will produce new and improved propulsion engines. Several examples and permutations are discussed below.

Similar to the platform 40, another basic propulsion engine, teaching device and concept demonstrator can be constructed with the base 30 and the magnets 26 and 28 shown and discussed with FIG. 4A and FIG. 4B. By modifying the base 30 with a predetermined length, the ferromagnetic body 22 can be placed starting in a stationary position on the base 30 disposed in the magnetic field of the magnets 26 and 28. In such a manner to allow the magnetic forces of attraction in the magnetic flux zone 32 to do work and attract the body 22 toward the magnetic zone 32. With the incremental acceleration of the body 22 over the length of the distance the body 22 travels toward the magnetic flux zone 32, and the sudden deceleration of the body 22 caused by the magnetic collision between the body 22 and the magnetic forces of attraction in the magnetic zone 32, the magnetic collision produces a propulsion force that propels the base 30 and the body 22 in the direction of the resultant propelling force. This experimental test has been done with a ferromagnetic steel ball (a 13 millimeter ball bearing) as the conveyor and two neodymium magnets mounted on a 4 centimeter piece of aluminum channel (the type of aluminum channel that can be purchased in a hardware store). The magnetic collision between the conveyor and the magnetic field between the two magnets generates a pulse of propellantless thrust that propels the aluminum frame forward for a distance greater than the length of the aluminum channel. The same experiment using a similar size permanent magnet sphere in the attraction mode generates a much larger propelling force that generates much larger displacement distances in comparison to the steel ball conveyor. The same experiment with permanent magnets that repel each other generates propelling forces in proportion to the speed of the approaching magnet.

In another embodiment of the propulsion platform 40, the permanent magnet 44, as a source of magnetic field can be replaced with an electromagnet. The electromagnet may include controlling means to switch-on and switch-off the electromagnet for only a predetermined length of time with additional controlling means to vary the magnetic field intensity. By this method, the electromagnet can be switched off at the appropriate time to allow a predetermined amount of leftover momentum in the conveyor. By adding means for the return of the conveyor to the starting place, the cycle of propulsion can be repeated any number of times. The leftover momentum will allow the return of the conveyor to the starting place and repeat the cycle of propulsion again.

In another embodiment of the propulsion platform 40, the permanent magnet 44 as a source of magnetic field can be placed on top of the frame 42 with an adhesive or any other means of attachment, method, or hardware to hold the source of magnetic field, whether a permanent magnet or an electromagnet, in the frame 42; thus effectively eliminating the use of the cavity 44 as a means of attachment to the frame 42.

In another embodiment, the base frame may be constructed of a non magnetic material with an alloy mixed with a predetermined amount of a ferromagnetic material or a magnet on one isolated end zone in the base frame to cooperate magnetically and interact with a conveyor made of a permanent magnet or an electromagnet. In this embodiment, as a source of magnetic field, the permanent magnet or the electromagnetic conveyor on one end of the base frame will be attracted to the magnetic zone on the other end of the base frame. The acceleration of the magnetic conveyor toward the magnetic zone generates the energy of motion that with the subsequent magnetic collision produced by the forces of magnetic attraction between the magnetic conveyor and the magnetic material zone on the base frame translate into the propelling force of the device.

In another embodiment, an additional or additional sources of magnetic field to supplement the magnetic accelerator 58 can be added to the magnetic flux drive 52 to augment the magnitude of the magnetic field that accelerate the conveyor 62. A single magnetic source converging toward the closed circuit 56 generates a gradient of magnetic field forces in relation to the circuit 56. The addition of more permanent magnets that cooperate magnetically with the already in place accelerator 58 will increase the thrust output of the drive 52. The added magnetic accelerator can be placed opposite to the accelerator 58 inside the space enclosed by the circuit 56, or in close proximity to cooperate magnetically with the accelerator 58. The addition will increase the local intensity of the magnetic field that penetrates into the track 74. The augmented magnetic field that penetrates into the track 74 will increase the acceleration of the conveyor 62 to a higher magnitude.

Similarly, an additional decelerator or decelerators can be mounted parallel to and opposite to the decelerator 60 inside the inner space enclosed by the circuit 56 or about the location of the decelerator 60. The enhanced decelerator 60 will increase the strength of the decelerating magnetic field inside the track 74. The cooperation of the newly assembled and enhanced decelerator will increase the strength of the magnetic field that collides and decelerate the conveyor 62 so as to increase the propulsive thrust output of the resultant magnetic flux drive.

In addition to employing stronger magnets; or any number of magnets surrounding the space of the track 74 between the magnetic inlet 66 and the magnetic outlet 68 or about the vicinity of the permanent magnets that make up the magnetic accelerator can be shaped like a solenoid cone such that, the smaller diameter of the conical accelerator converges into the magnetic outlet 68. As a result of this conical arrangement, the greater concentration of magnetic field lines and magnetic field gradient intensity will be in the magnetic outlet 68. The greater magnetic field intensity in the outlet 68 will produce a higher magnetic field intensity that increases the magnitude of the acceleration and the exit velocity of the conveyor 62. In addition to this arrangement, the magnetic field of the resultant decelerator can be placed at a predetermined distances to allow the magnetic fields of the improved accelerator and the decelerator to cooperate magnetically so as to augment the thrust output of the resultant new and improved magnetic flux drive.

In another embodiment, the magnetic flux drive 76 can be modified with additional electromagnetic accelerators to cooperate magnetically with the electromagnetic accelerator 78 in order to increase the acceleration of conveyor 62. Similarly, additional accelerators to cooperate magnetically with the decelerator 60 will increase the strength of the magnetic field that collides with the conveyor 62. The magnetic collision between the higher velocity conveyor 62 and the stronger magnetic field will generate a higher conveyor 62 deceleration. The additional accelerators producing a stronger magnetic field take advantage of the increased acceleration of the conveyor 62 contributes to produce a higher propulsive thrust output for the improved magnetic flux drive. Similarly, a combination of a plurality of electromagnets and a plurality of permanent magnets surrounding the closed circuit 56 for the acceleration and the deceleration of the conveyor 62 can be employed to achieve the same beneficial results of a higher thrust output for the magnetic flux drive. In addition to a plurality of sources of magnetic field, the inclusion of a plurality of conveyors will also increase the cyclical thrust output of the magnetic flux drive 76.

Moreover, controlling means to switch-on and switch-off or to vary the magnetic field intensity at predetermined moments in time can be employed to increase the thrust output of the drive. The controlling means can be employed to decrease the electric power input to the electromagnets by controlling the switch on amount of time, and to increase the efficiency of the thrust output of the magnetic flux drive in relation to the electric energy input to the electromagnets.

In another embodiment of a new and improved propulsion engine, the magnetic flux drive 84 can be improved with an additional electromagnetic accelerator opposite to the accelerator 78 to increase the acceleration of the conveyor 62. An additional source of magnetic field, such as an electromagnet opposite side to the decelerator 86 can be added to cooperate magnetically. The magnetic cooperation will increase the intensity of the magnetic field that collide with and decelerate the conveyor 62 with a resultant increase in the magnitude of the propulsive thrust output of the magnetic flux drive 84. In addition, a plurality of sources of magnetic field such as, additional electromagnets for the electromagnetic accelerators and additional electromagnets for the decelerator can be employed to achieve a further increase in magnitude of the propulsive thrust output of the resultant new and improved magnetic flux drive. Adding linear electric motors for the acceleration of the conveyor 62 will also increase the overall thrust output of the drive 84.

In another related embodiment, the magnetic flux drive 92 can be improved by adding additional magnets or a plurality of permanent magnets or electromagnets to cooperate magnetically with the decelerator 60 to increase the strength of the magnetic field that collides with and decelerate the conveyor 62. The added sources of magnetic field will augment the thrust output of the new and improved magnetic flux drive.

In another related improvement, additional sources of magnetic field such as permanent magnets and electromagnets for a single magnetic accelerator or a plurality of magnetic accelerators added to the magnetic flux drive 92 will increase the propulsive thrust. The addition of a single or a plurality of magnetic accelerators between the outlet 106 and the decelerator 60 to augment the acceleration that the mechanical accelerator will give to a single conveyor 62 or a plurality of conveyors 62 will result in an increase in the overall propulsive thrust of the new and improved magnetic flux drive.

In another new and improved magnetic flux drive 92, the conveyor 62 can be a permanent magnet launched from the accelerator 94 toward the decelerator 60. The magnetic conveyor can be placed in the repulsion mode by arranging the magnetic polarity of the magnetic conveyor to coincide with like magnetic polarity of the conveyor 60 to repel each other. The magnetic collision between the magnetic conveyor and the decelerator 60 will be repulsive. Both the magnetic conveyor and the decelerator 60 will repel each other to cause the deceleration of the magnetic conveyor. The excess momentum in the magnetic conveyor will allow the conveyor to overcome and pass thru the repelling magnetic field of the decelerator 60. The new and improved magnetic flux drive that employs the repulsive forces of colliding magnetic fields will produce a propellantless propulsion force without the ejection of a mass of propellant from the new and improved magnetic flux drive.

In the descriptions above, the size of the conveyor 62 occupies a reasonable portion of the track 74 in proportion to the width and height available in the cross section of the circuit 56. The size of the conveyor 62 is not a limitation. Other sizes of the conveyor 62 are equally adaptable to the task.

For example, if the size of the conveyor 62 is reduced to that of microscopic particles, then a plurality of microscopic particles can be accelerated by the accelerating magnetic field, and decelerated by the decelerating magnetic field to produce the propellantless thrust output of the magnetic flux drive. Similarly, with the inclusion of controllable electromagnets on which the magnitude of the amplitude and the duration of the electromagnetic field being applied for the acceleration and deceleration of the conveyor or conveyor particles can be employed in the practice of the invention. The use of micro conveyors of a predetermined quantity that equal a useful amount of mass to produce useful amounts of thrust large or small useful for propulsion generates new permutations and improvements in the magnetic flux drive technology. In the same manner that particles travel at high speeds in particle accelerator, a plurality of microscopic conveyors traveling in a highway of electromagnetic forces for the acceleration and deceleration of microscopic conveyors will produce high levels or low levels of thrust; in addition to new and improved magnetic flux drives.

The electromagnetic field is a very efficient means for the acceleration and deceleration of conveyors. A magnetic collision is a very efficient method to convert momentum and kinetic energy into a force useful for propulsion. Whether the conveyors are made of ferromagnetic particles, permanents magnets particles such as magnetite, or any other suitable material susceptible to the influence of a magnetic field, the technology of electric linear motors and particles accelerators is equally suitable for applications in the magnetic flux drive. With the inclusion of particle accelerator technology, the acceleration of conveyors of all sizes and shapes to a higher magnitude can be achieved. Similarly, with higher levels of acceleration, higher levels of deceleration and collision forces can be achieved for the production of propellantless thrust of very high magnitude useful for high speed propulsion.

As the reader can see in the disclosure herein, the magnetic flux drive is a novel, useful, and efficient propellantless propulsion engine. Useful for the propulsion of land driven motor vehicles such as cars, vans and trucks, in addition to boats, seafaring ships, submarines, airplanes, space ships traveling in the vacuum of space, satellites and any vehicle or frame to which the magnetic flux drive is attached to for propulsion.

The disclosures herein are not to be interpreted as limitations and restrictions. There are additional embodiments and permutations implied and anticipated that can be found in the teachings and operation of the magnetic flux drive, a prime mover that generates a propelling force without the ejection of a mass of propellant from the magnetic flux drive.

I claim:

1. A propulsion device comprising a base frame, a source of magnetic field, a conveyor susceptible to the magnetic influence of said source of magnetic field, whereby the magnetic forces of attraction from said source of magnetic field in said frame accelerates said conveyor toward said magnetic field, whereby the magnetic collision between said conveyor and said magnetic field generates a propulsion force without the ejection of a mass of propellant.

2. The propulsion device in claim 1 in which said source of magnetic field is a permanent magnet.

3. The propulsion device in claim 1 wherein said conveyor is made of a ferromagnetic material susceptible to the magnetic influence of said source of magnetic field.

4. A propulsion device comprising a base frame, a conveyor, a track, means for the continuous cyclical circulation of said conveyor, means for the acceleration of said conveyor, means for the deceleration of said conveyor with a magnetic field, whereby the acceleration of said conveyor endows said conveyor with a predetermined energy of motion, and whereby the deceleration of said conveyor with a decelerating magnetic field by way of a magnetic collision between said conveyor and said magnetic field generates a propellantless propulsion force.

5. The device in claim 4 in which said means enclosing said track for the cyclical circulation of said conveyor is a closed circuit made of a non magnetic material.

6. The device in claim 4 in which said conveyor is made of a ferromagnetic material.

7. The device in claim 4 in which said means to accelerate said conveyor is a permanent magnet.

8. The device in claim 4 in which said means to accelerate said conveyor is an electromagnet.

9. The device in claim 4 in which said means to accelerate said conveyor is a mechanical accelerator.

10. The device in claim 4 in which said means to decelerate said conveyor is a permanent magnet.

11. The device in claim 4 in which said means to decelerate said conveyor is an electromagnet.

12. A propulsion device comprising: providing a base frame, providing a conveyor, providing means for the continuous cyclical circulation of said conveyor comprising a track, providing means for the acceleration of said conveyor, providing means for the deceleration of said conveyor with a decelerating magnetic field, whereby the acceleration of said conveyor endows said conveyor with a predetermined energy of motion, and whereby the deceleration of said conveyor with said decelerating magnetic field by way of a magnetic collision between said conveyor and said decelerating magnetic field generates a propulsion force.

13. The device in claim 12 in which said means enclosing said track for the cyclical circulation of said conveyor is a closed circuit made of a non magnetic material.

14. The device in claim 12 in which said conveyor is made of a ferromagnetic material.

15. The device in claim 12 in which said means to accelerate said conveyor is a permanent magnet.

16. The device in claim 12 in which said means to accelerate said conveyor is a mechanical accelerator.

17. The device in claim 12 in which said means to accelerate said conveyor is an electromagnet.

18. The device in claim 12 in which said means to decelerate said conveyor is a permanent magnet.

19. The device in claim 12 in which said means to decelerate said conveyor is an electromagnet.
